(19) United States
(12) Patent Application Publication
(10) Pub. No.: US 2015/0262232 A1
(43) Pub. Date: Sep. 17, 2015

(54) SERVING AN ADVERTISEMENT ACCORDING TO A USER'S SHOPPING INTEREST

(71) Applicant: Google Inc., Mountain View, CA (US)

(72) Inventors: Daniel Victor Klein, Pittsburgh, PA (US); Dean Kenneth Jackson, Pittsburgh, PA (US)

(73) Assignee: Google Inc., Mountain View, CA (US)

(21) Appl. No.: 13/686,636

(22) Filed: Nov. 27, 2012

(51) Int. Cl. G06Q 30/02

(52) U.S. Cl. CPC G06Q 30/0255

(57) ABSTRACT

Methods and systems are provided for selecting and serving content, such as promotional content, to a user in accordance with a shopping interest of the user, location information for the user (e.g., location information associated with the user's mobile device), or both. A content delivery system is configured to make inferences on which promotional content to deliver to a user based on different types of signals. These signals include, for example, regular geolocation signals (e.g., GPS), fine-grained geolocation signals (e.g., DGPS, site-specific or site-provided signals, etc.), near-field communication (NFC) signals, purchase information signals, browsing history signals, and any combination of such signals. A shopping interest of a user is determined based on location information and/or transaction information indicating whether or not the user has not conducted a related transaction in a time period.

### TECHNICAL FIELD

The present disclosure generally relates to systems and methods for providing content to users. More specifically, aspects of the present disclosure relate to selecting content items to send to a user based on different types of signals that indicate the user's interests and location.

### BACKGROUND

A customer's experience in a retail setting, such as a store or market, may be enhanced by presenting the customer with various products and/or services that appeal to the customer's interests, but that the customer may not otherwise be aware of.

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a method comprising: receiving, using one or more computing devices, multiple locations over time for a mobile device associated with a user; determining that the multiple locations over time are associated with a vicinity of a merchant site; determining a shopping interest of the user based at least in part on the determination that the multiple locations over time are associated with the vicinity of the merchant site, wherein the time is within a threshold period of time; selecting promotional content based at least in part on the shopping interest of the user; and sending the selected promotional content to the mobile device associated with the user.

In another embodiment, the method further comprises receiving, at the one or more computing devices, transaction information indicating that the user has not conducted a related transaction in a threshold time period.

In another embodiment, determining the shopping interest of the user includes identifying one or more products located in a vicinity of the mobile device at the merchant site.

In yet another embodiment, in which a first product is located in a first vicinity of the merchant site and a second product is located in a second vicinity of the merchant site, the first product being related to the second product, the method further comprises providing, for presentation on a display of the mobile device, the promotional content when the mobile device is in one of the first vicinity and the second vicinity of the merchant site.

Another embodiment of the disclosure relates to a system comprising at least one processor and a computer-readable medium coupled to the at least one processor having instructions stored thereon which, when executed by the at least one processor, causes the at least one processor to: receive multiple locations over time for a mobile device associated with a user; determine that the multiple locations over time are associated with a vicinity of a merchant site; determine a shopping interest of the user based at least in part on the determination that the multiple locations over time are associated with the vicinity of the merchant site, wherein the time is within a threshold period of time; select promotional content based at least in part on the shopping interest of the user; and send the selected promotional content to the mobile device associated with the user.

In another embodiment, the at least one processor of the system is further caused to receive transaction information indicating that the user has not conducted a related transaction in a threshold period of time.

In yet another embodiment, the at least one processor of the system is further caused to identify one or more products located in a vicinity of the mobile device at the merchant site.

Still another embodiment of the disclosure relates to one or more non-transitory computer-readable media storing computer-executable instructions that, when executed, cause at least one computer device to perform: receiving multiple locations over time for a mobile device associated with a user; determining that the multiple locations over time are associated with a vicinity of a merchant site; determining a shopping interest of the user based at least in part on the determination that the multiple locations over time are associated with the vicinity of the merchant site, wherein the time is within a threshold period of time; selecting promotional content based at least in part on the shopping interest of the user; and sending the selected promotional content to the mobile device associated with the user.

In one or more other embodiments, the methods, systems, and computer-readable media presented herein may optionally include one or more of the following additional features: the transaction information is received from one or more point-of-sale devices of the merchant site; the transaction information is received from a mobile payment system including one or more near-field-communication devices; the transaction information is received from one or more servers of a near-field-communication service provider; the transaction information is received from one or more servers of a credit card provider; the related transaction is a sale of a product; the related transaction is a return of a product; the threshold period of time comprises multiple non-contiguous periods of time; the promotional content is selected in accordance with the one or more products located in a vicinity of the mobile device at the merchant site; the promotional content comprises an advertisement of a first product related to a second product that is in the vicinity of the merchant site; and/or the mobile device of the user is a computing device of the user.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the disclosure will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a block diagram illustrating an example content serving system according to one or more embodiments described herein.

FIG. 2 illustrates a conceptual overview of one or more embodiments described herein.

FIG. 3 is an example user interface screen according to one or more embodiments described herein.

FIG. 4 is a flowchart illustrating an example method for determining interests of a user based on a location of the user and/or related transactions of the user according to one or more embodiments described herein.

FIG. 5 is a flowchart illustrating an example method for selecting and providing content to a user based on the user's interests and/or location according to one or more embodiments described herein.

FIG. 6 is a block diagram illustrating an example computing device arranged for selecting and providing content to a user based on the user's interests and/or location according to one or more embodiments described herein.

The headings provided herein are for convenience only and do not necessarily affect the scope or meaning of the claimed disclosure.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Overview

Various examples will now be described. The following description provides specific details for a thorough understanding and enabling description of these examples. One skilled in the relevant art will understand, however, that the various embodiments may be practiced without many of these details. Likewise, one skilled in the relevant art will also understand that the embodiments can include many other obvious features not described in detail herein. Additionally, some well-known structures or functions may not be shown or described in detail below, so as to avoid unnecessarily obscuring the relevant description.

Users may want advertising that is specialized for them. In such cases, they may desire that their location near a store will let a system know that they are interested in a particular store. The users may accomplish this by enabling or utilizing a service, installing an app, etc. The system may then determine that the user has been in a particular area (e.g., within a store) for more than a threshold period of time (e.g., 10 minutes), and therefrom serve, for example, an advertisement or offer related to that store. The advertisement or offer may be for that particular store or for another related or nearby store.

Embodiments of the present disclosure relate to methods, systems, and techniques for selecting and providing content, such as promotional content (e.g., advertisements or simply “ads”), to a user in accordance with a shopping interest of the user, location information for the user (e.g., location information associated with the user's mobile device), or both. As will be described in greater detail herein, a content delivery system is configured to make inferences on which ads to deliver to a user based on different types of signals (e.g., signal information). These signals may include, for example, regular geolocation signals (e.g., GPS), fine-grained geolocation signals (e.g., DGPS, site-specific or site-provided signals, etc.), near-field communication (NFC) signals, purchase information signals, browsing history signals, and any combination of such signals. Various other types of signals may also be used in the ad delivery system in addition to or instead of the signal types described above.

An example method includes determining a shopping interest of a user based on location information, determining that the user has not conducted a related transaction in a time period, selecting promotional content in accordance with the shopping interest of the user, and serving the promotional content to a device of the user for display to the user.

While the following description includes many examples presented in the context of advertisements and makes reference to a user's “shopping interest,” the scope of the present disclosure is not limited to advertisements or shopping-related activities. Instead, embodiments and features of the present disclosure are applicable to various content items in addition to or instead of advertisements, as well as a variety of activities and/or interests other than shopping. For example, in one or more embodiments a user may be served with purely informational content, such as statistics relating to the user's frequency of visits to a particular venue or neighborhood within a city.

An advertisement is an item of promotional content (e.g., an “entity”) that presents a piece of information to a user and is designed to be used in whole or in part by the user. Ads may be provided (e.g., served, sent, presented, etc.) to a user in electronic form, such as banner ads on a web page, as ads presented with search results, as ads presented with emails, and the like. Such electronic ads may also contain links to other electronic content including web pages, images, audio files, video files, etc.

Example Processes

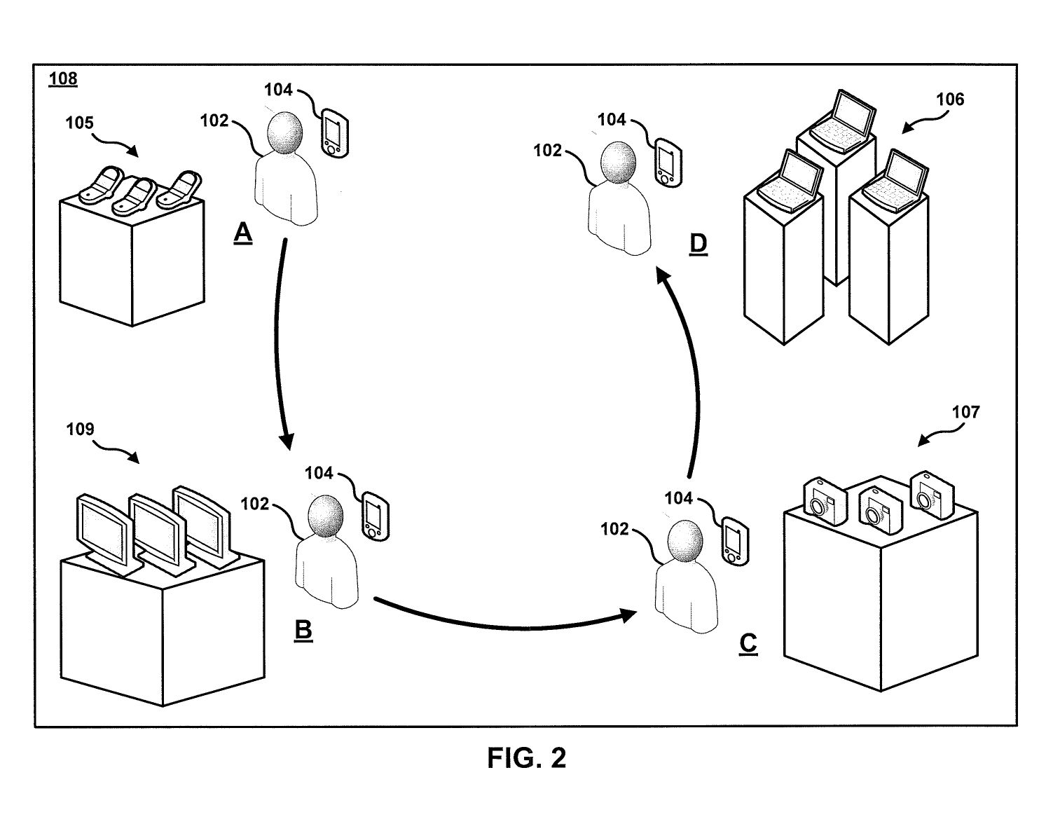

FIG. 2 illustrates a conceptual overview of the method according to at least one embodiment of the disclosure. The following overview provides a high-level illustration. More detailed aspects and variations of the methods and systems of the present disclosure will be described below.

FIG. 2 shows a user 102 carrying a user device 104 at a merchant site (e.g., a store, shopping mall, etc.) 108. In at least the present example, the merchant site 108 will be referred to as the “store” for purposes of brevity. However, it should be noted that the examples and embodiments described herein are equally applicable in any other merchant site. A merchant site can be an indoor site, such as a typical store, or an outdoor site, such as a car dealership. The store 108 shown in FIG. 2 is comprised of many distinct areas including areas “A”, “B”, “C”, and “D”, each of which is associated with a different product group on display for sale. For example, area “A” has cellular phones on display (and may be referred to as “cell phone area” 105), area “B” has computer monitors on display (and may be referred to as “monitors area” 109), area “C” has cameras on display (and may be referred to as “cameras area” 107), and area “D” has laptop computers on display (and may be referred to as “laptop area” 106).

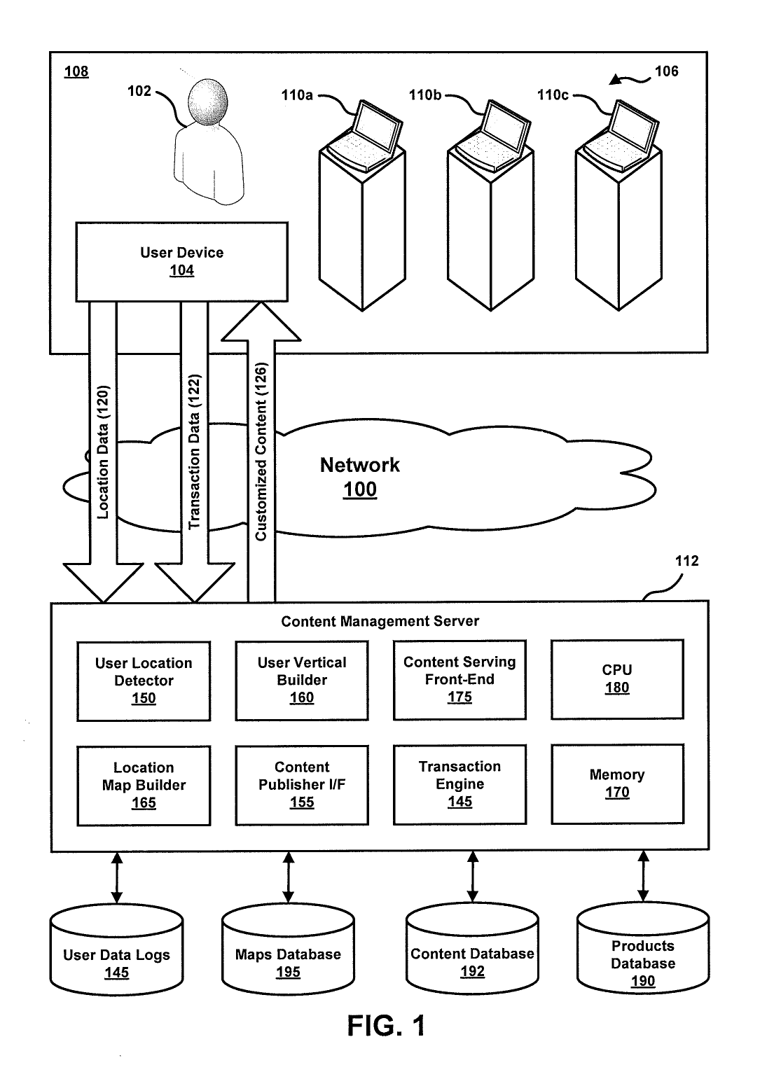

The user device 104 is a portable or mobile user device, such as a smart phone, that is able to determine its location over time. As will be described in greater detail below, a content serving system is able to use the user device's location information, by itself or together with other information, to determine a location of the user device 104 in the store 108. This is referred to as an “in-store location” of the user device 104. Assume, for purposes of the present overview, that the resolution of the user device's in-store location is sufficiently accurate to indicate that the user device 104 is in the laptop area 106 of the store 108. Based on the user device's in-store location, the content serving system (e.g., via a content management server 112, as shown in FIG. 1 and further described below) is able to infer that the user 102 is located in the laptop area 106 of the store 108.

The content management server 112 uses the in-store location of the user device 104 to determine a shopping interest of the user 102. In particular, the content management server 112 determines whether the user device 104 remains in the laptop area 106 of the store 108 for a threshold time period. If the content management server 112 determines that the user device 104 does remain in the laptop area 106 for the threshold time period, then the content management server 112 determines that the user 102 has a shopping interest in laptops. Additional details regarding the processes that may be performed after the determination of the user's interest will be provided after the following description of various features of the content serving system.

In at least one embodiment, the threshold time period for which the user device 104 must remain in a particular area of the store (e.g., laptop area 106 of the store 108) may be established by assessing the purchasing habits of previous visitors to that area of the store. For example, if it is found (e.g., by analyzing purchasing records and histories for a given store) that visitors who spent at least 7 minutes in a particular area of the store were more than 50% likely to purchase a product from that area of the store in the next three months thereafter, then the threshold time period for that area of the store may be set to 7 minutes.

In addition to the amount of time the user device 104 remains in a particular area of the store 108, various other types of signals may also be utilized by the content management server 112 to determine, update, or refine a shopping interest of the user 102. For example, in one or more embodiments the content management server 112 may also receive signal information indicating the number of visits by the user to the same area in a store (e.g., laptop area 106 of the store 108), the number of visits by the user to similar areas in different stores, queries made by the user on one or more search engines, activity (e.g., discussions, posts, endorsements, etc.) by the user in a social network, past purchase histories for the user, as well as numerous other types of information that may be useful in determining one or more shopping interests of the user 102.

FIG. 1 shows an example content serving system and surrounding environment in which various embodiments described herein may be implemented. The example system and environment shown includes user 102 with user device 104, both of which are located in the laptop area 106 of the store 108. The laptop area 106 has several laptop computers 110a-110c on display for sale. Also shown is content management server 112, which may be one or more servers, computers, or the like.

The example environment also includes a network 100, such as a local area network (LAN), a wide area network (WAN), the Internet, or a combination thereof. The network 100 connects the user device 104 and the content management server 112 such that various types of data and information can be exchanged or communicated over the network 100. The network 100 can also connect additional devices and servers of the same or different type (not shown). The example system also includes a products database 190, a content database 192, a maps database 195, and user data logs 145. These and other components of the system and environment shown in FIG. 1 will be described in greater detail below.

The user device 104 can be any of a number of different electronic devices under control of a user and capable of requesting and receiving resources. As used herein, a resource is any data that can be provided over the network 100, and can be identified by a resource address associated with the resource. Examples of resources include images, video, HTML pages, content (e.g., words, phrases, images, etc.), embedded information such as meta-information and hyperlinks, and also embedded instructions, such as JavaScript scripts. Examples of the user device 104 can be one or more personal computers, mobile telephones, personal digital assistants (PDAs), television systems, etc., that are capable of sending and receiving data over the network 100. The user device 104 can also be a portable user device, such as a laptop computer, tablet computer, mobile communication device (e.g., cell phone, smartphone), and the like, capable of also sending and receiving data over the network 100.

The user device 104 may include one or more web browser tools for viewing and interacting with web pages via a wired or wireless internet connection and/or via a mobile data exchange connection such as cellular, optical, near field communication, or some combination thereof.

Content publishers, such as advertisers, may directly or indirectly submit, log, maintain, and utilize information in the content management server 112. For example, content publishers may access and/or interact with the content management server 112 via a content publisher interface (I/F) 155. Content and other information submitted or otherwise utilized by content publishers may be stored in a content database 192 for easy retrieval via the content management server 112. Additionally, depending on the implementation, content publishers may be able to access and/or interact with the content management server 112 in one or more other ways.

In addition to the content publisher interface 155, the content management server 112 may also include a computer processing unit (CPU) 180, a memory 170, a transaction engine 145, a user location detector 150, a content-serving front-end 175, a user vertical builder 160, and a location map builder 165.

In at least some embodiments, content publishers provide content items (e.g., advertisements) to the content management server 112 via the content publisher interface 155, and the content serving front-end 175 of the content management server 112, in turn, serves the content items as customized content 126 to the user device 104 using various methods described in greater detail below. Such customized (e.g., personalized) content 126 may be provided to the user device 104 in response to location data 120 and/or transaction data 122 being received by the content management server 112, and a determination being made by, for example, the user location detector 150 that the user is at or near a particular area (e.g., laptop area 106) of the store 108.

The customized content 126 provided to the user device 104 may be in the form of text, images, videos, audio files, as well as content combining one or more of any such forms. In at least one arrangement, advertisements tailored to the user's 102 interests may be provided to the user device 104 in the form of graphical ads, such as banner ads, audio ads, video ads, still image ads, coupons, offers, or any combination of these forms. Such content comprising the customized content 126 may also include embedded information or data, including links to one or more web pages, meta-information, and/or machine-executable instructions.

It should be noted that in one or more of the embodiments described herein, the information obtained for a particular user (e.g., information about the in-store location of the user (determined from, for example, the user device 104), information about the shopping interests of the user, etc.) may be used immediately or at a later time. For example, if the user uses their mobile device while in a store, then the information obtained for the user may be more helpful if used immediately. However, if it is determined that the user is likely to return to a store (e.g., based on the particular product area in which the user was previously browsing being a product area in which users typically return to make a purchase), then the information may be better utilized at a later time (e.g., a day or two after the user leaves the store) to remind the user about a particular product.

Additionally, the information about the shopping interests of a user may be used to select and provide promotional content to the user on any device the user is logged in on. Furthermore, the strength of a signal obtained from a user's device (e.g., user device 104 as shown in FIG. 1) may decay over time. For example, while a user may spend 20 minutes looking at laptops on July 1^{st}, and may be very interested in laptops at that time, the user will likely not be as interested in laptops six months later.

In any of the embodiments of the present disclosure, conventional content and/or ad serving methods and systems may be utilized in conjunction with the various features described herein. Additionally, in at least some embodiments, the content management server 112 identifies one or more candidate content items from the content database 192, selects a particular combination of the candidate content items based on determined interests of the user through, for example, the user vertical builder 160 and/or the user data logs 145, and provides the selected combination of content items (e.g., as the customized content 126) to the user device 104 for presentation to the user 102. Depending on the implementation, the content management server 112 may conduct an auction to determine which of a certain type of content item (e.g., ads) will be selected for presentation as, or with, the customized content 126.

In at least some embodiments, the determination of whether or not the user device 104 remains in a certain area of the store 108 is made by the user location detector 150 based on location data 122 received from the user device 104 and additional information from one or more other components of the content management server 112. For example, the user location detector 150 may use the location data 122 received from the user device 104 in conjunction with information about the layout of the store 108 maintained in the maps database 195. Furthermore, the location map builder 165 of the content management server 112 may utilize data and information stored in the maps database 195 to generate a layout of the particular store (e.g., store 108) indicated by the location data 122 received from the user device 104.

The content management server 112 also determines whether the user 102 made a related transaction in the threshold time period. Types of related transactions include a purchase, a return, or an exchange of an entity, such as a product or service. More detailed aspects of related transactions and entities, and how related transactions can be determined, will be discussed in greater detail below.

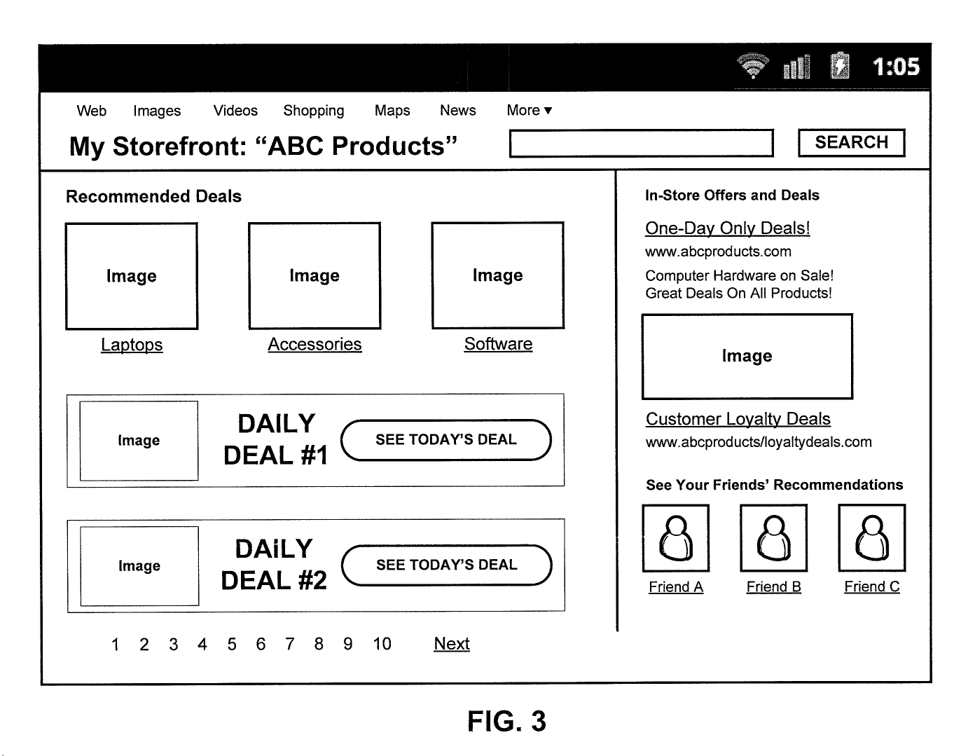

After determining the shopping interest of the user 102 and whether the user 102 made a related transaction, the content management server 112 may be able to intelligently select content (e.g., advertising content) and serve the content to the user device 104 for presentation to the user 102. Assume, for purposes of the present description, that the content management server 112 determines that the user 102 has a shopping interest in laptops. Based on this determination, the content management server 112 selects ad content corresponding to laptops and related products. To clarify this example, FIG. 3 shows three ads: an ad 310 for a laptop, an ad 325 for a laptop accessory, and an ad 330 for a software product. Of course, in practice, there can be additional or different ads of the illustrated products or of other products or services.

As mentioned, the content serving system (e.g., via content management server 112) may be able to determine whether the user 102 made a related transaction in the threshold period. The following description details how the content serving system serves content (e.g., customized content 126, such as ads) when the user 102 has made a related transaction. Also described below are examples of how the content serving system serves content when the user 102 did not make a related transaction.

Assuming that the user 102 made a related transaction in the threshold period, content management server 112 may determine what type of transaction occurred and what product was transacted. In at least one embodiment, this determination may be made by the transaction engine 145 of the content management server 112 based on transaction data 124 received at the content management server 112. In at one or more embodiments, the transaction engine 145 may also utilize additional information stored in the products database 190 for the particular store 108. Based on the transaction type, the transacted product, or both, the content management server 112 can infer which of a plurality of candidate ads will interest the user 102, and can select and serve one or more items of ad content to the user device 104 accordingly.

For example, assume that the content management server 112 determines that the transaction type is a purchase of a product and that the transacted product is a laptop. The content management server 112 may then determine that the user 102 has already purchased a laptop and, therefore, can infer that the laptop ad 114 will not interest the user 102. Accordingly, the content management server 112 may select a laptop accessory ad or a software ad, or both, and serve the selected ad content to the user 102 via the user device 104.

As another example, assume that the content management server 112 determines that the transaction type is a return of a product and that the transacted product is a laptop. The content management server 112 may then determine that the user 102 has returned a laptop. The content management server 112 therefore can infer that the user 102 is not in need of a laptop of the type returned, that the user 102 is unlikely to be in need of software, and that the user 102 is unlikely to be in need of laptop accessories. Accordingly, the content management server 112 may select a laptop ad, assuming that the laptop ad relates to a different type of laptop than the laptop that was returned by the user 102. The content management server 112 may then serve the laptop ad to the user 102 via the user device 104.

As yet another example, assume that the content management server 112 determines that the transaction type is an exchange of a product and that a first laptop was exchanged for a second laptop. The content management server 112 may then determine that the user 102 has exchanged the first laptop for the second laptop. The content management server 112 can infer that a laptop ad will not interest the user 102 because the user 102 already owns the second laptop. Accordingly, the content management server 112 may select a laptop accessory ad, a software ad, or both, and serve the selected ad content to the user 102 via the user device 104.

On the other hand, assuming that the user 102 did not make a related purchase, the content management server 112 may be able to generally infer that the user wants to buy a laptop. Accordingly, the content management server 112 may select a laptop ad and present the laptop ad to the user device 104 of the user 102. The content management server 112 may also be able to infer more specifically that the user 102 wants to buy a laptop that is in the laptop area 106 of the store 108. For example, assume that the content management server 112 infers that the user 102 wants to buy one of the laptops 110a, 110b, and 110c. The content management server 112 may then serve the laptop ad to the user 102 when the user device 104 is determined to be in the laptop area 106 of the store 108. For example, the selected laptop ad can include information that is specific to the laptop 110a (for example, technical information on the laptop 110a, a coupon for the laptop 110a, or the like). In this way, the content management server 112 may be able to intelligently serve an ad to the user 102 at a time when the user 102 is near the laptop 110a and, therefore, more likely to purchase the laptop 110a.

It should be noted that in any of the various scenarios in which the methods or systems described herein collect personal information about users, or may make use of personal information, the users may be provided with an opportunity to control whether programs or features collect user information (e.g., information about a user's social network, social actions or activities, a user's preferences, or a user's current location), or to control whether and/or how to receive content from the content server that may be more relevant to the user. In various embodiments, the techniques herein will not be used unless the user decides to install a relevant application, enable a service within an application, or otherwise engage in the product. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, zip code, or state level), so that a particular location of a user cannot be determined. Thus, the user may have control over how information is collected about the user and used by a content server.

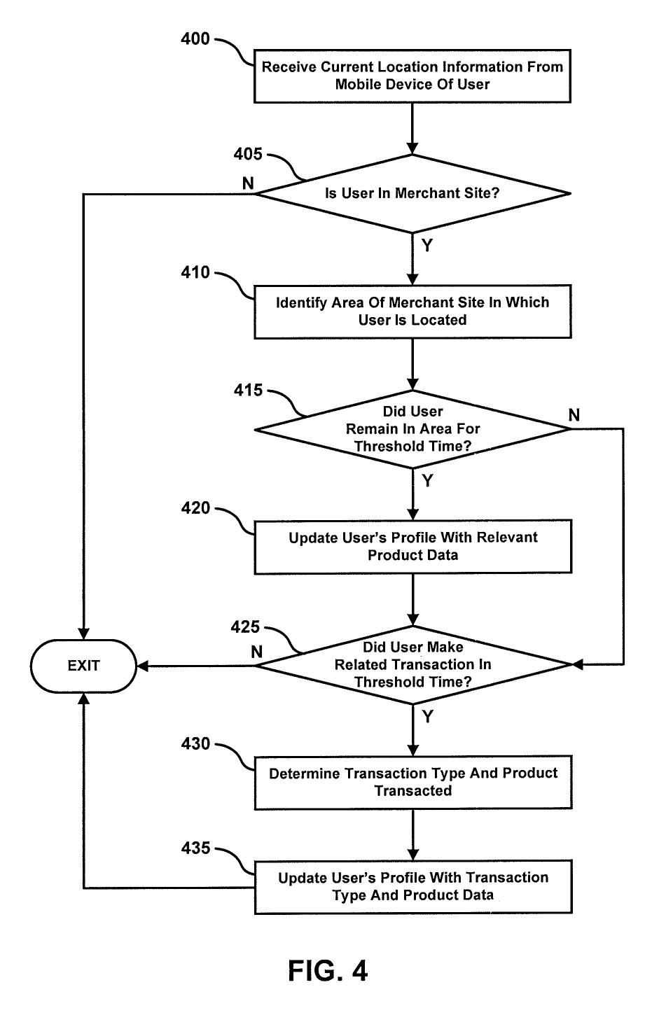

FIG. 4 illustrates an example process for determining one or more interests (e.g., shopping interests) of a user based on a location of the user and/or related transactions of the user according to one or more embodiments described herein.

The process begins at block 400 where current location information may be received from a mobile device of the user (e.g., location data 120 may be received at content management server 112 from user device 104 of user 102 as shown in FIG. 1). In at least one embodiment, the current location information may be received by a user location detection device (e.g., user location detector 150 as shown in FIG. 1). It should be noted that in at least one embodiment block 400 may occur while one or more previous iterations of the process illustrated in FIG. 4 are still in progress. For example, the process may run each time a user's location changes. Therefore, if a user is constantly on the move (e.g., walking through a shopping mall) then the process shown in FIG. 4 may be performed repeatedly while the user's location continues to change. Additionally, in at least one implementation, a new iteration of the process may begin before the previous iteration has completed, such that two or more iterations are occurring simultaneously.

Following receipt of the current location information from the user's mobile device in block 400, the process moves to block 405 where a determination may be made about whether the user is located in a merchant site (e.g., store 108 as shown in FIG. 1). In at least one embodiment, the determination in block 405 may be made based on the current location information received in block 400. For example, the current location information received in block 400 may be compared (e.g., by location map builder 165 of content management server 112 as shown in FIG. 1) against merchant site data stored in a database (e.g., maps database 195 as shown in FIG. 1). Based on such a comparison, it may be determined in block 405 that the user is currently located in a particular merchant site, which may be identified from the stored merchant site data.

If it is determined in block 405 that the user is not located in a merchant site (e.g., the user's location is still changing, the user is in an area other than a merchant site, etc.), the process ends. However, if it is determined in block 405 that the user is located in a merchant site, then the process moves to block 410 where a particular area of the merchant site (e.g., laptop area 109 of store 108 as shown in FIG. 2) may be identified based on the user's location (e.g., the location of the mobile device of the user who has enabled the relevant service or installed the relevant application). In at least one embodiment, location data received from the mobile device of the user may be used in conjunction with information about the merchant site to identify the area of the merchant site in which the user is located (e.g., the user location detector 150 of the content management server 112 may use location data 122 received from user device 104 in conjunction with information about the layout of the store 108 maintained in the maps database 195 as shown in FIG. 1). Furthermore, in another embodiment block 410 may also include generating a layout of the merchant site based on the current location information received in block 400 and stored data about the merchant site (e.g., the location map builder 165 of the content management server 112 may utilize data and information stored in the maps database 195 to generate a layout of the particular store (e.g., store 108) indicated by the location data 122 received from the user device 104 as shown in FIG. 1).

The process continues to block 415 where a determination may be made as to whether the user remained in the area of the merchant site identified in block 410 for a threshold period of time. In at least one embodiment, the threshold period of time for which the user (e.g., the mobile device of the user) must remain in the identified area of the merchant site may be established by assessing the purchasing habits of previous visitors to that area of the store, as described above with respect to FIG. 1.

If it is determined in block 415 that the user did not remain in the area of the merchant site identified in block 410 for the threshold period of time, the process moves to block 425 where it may be determined whether the user made a related transaction in the threshold period of time. On the other hand, if it is determined in block 415 that the user did remain in the area of the merchant site identified in block 410 for the threshold period of time, the process first moves to block 420 before going to block 425. In block 420, the user's profile (e.g., maintained by the user vertical builder 160 of the content management server 112, and stored in one or more of the user data logs 145 as shown in FIG. 1) may be updated with relevant product data based on the particular area of the merchant site identified in block 410. For example, if it is determined that the user remained in the laptop area of a store (e.g., laptop area 109 of store 108 as shown in FIG. 1) for the threshold period of time, then in block 420 the user's profile may be updated with relevant data about one or more laptop computers (e.g., obtained from the products database 190 as shown in FIG. 1).

In block 425 a determination may be made as to whether the user made a related transaction in the threshold period of time. In at least one embodiment, it may be determined whether any of a variety of related transactions occurred in the threshold period of time including a purchase, a return, an exchange of an entity, such as a product or service, and the like. The particular type of transaction and/or any products involved in the transaction may be determined in block 430 as further described below. However, if it is determined in block 425 that no related transaction was made by the user in the threshold period of time, the process ends.

If it is found in block 425 that the user did make a related transaction in the threshold period of time, then in block 430 a determination may be made about the particular type of transaction and/or the particular product or service involved in the transaction. In at least the implementation shown in FIG. 1, assuming that the user (e.g., user 102) makes a related transaction in the threshold period of time, the content management server 112 may determine what type of transaction occurred and what product was transacted. For example, the determination may be made by the transaction engine 145 of the content management server 112 based on transaction data 124 received at the content management server 112. In another embodiment, the transaction engine 145 may also utilize additional information stored in the products database 190 for the particular merchant site (e.g., store 108) to determine the transaction type and any products involved in block 430 of the process shown in FIG. 4.

Following the determination made in block 430, the process continues to block 435 where the user's profile is updated with the transaction type and/or any relevant product data.

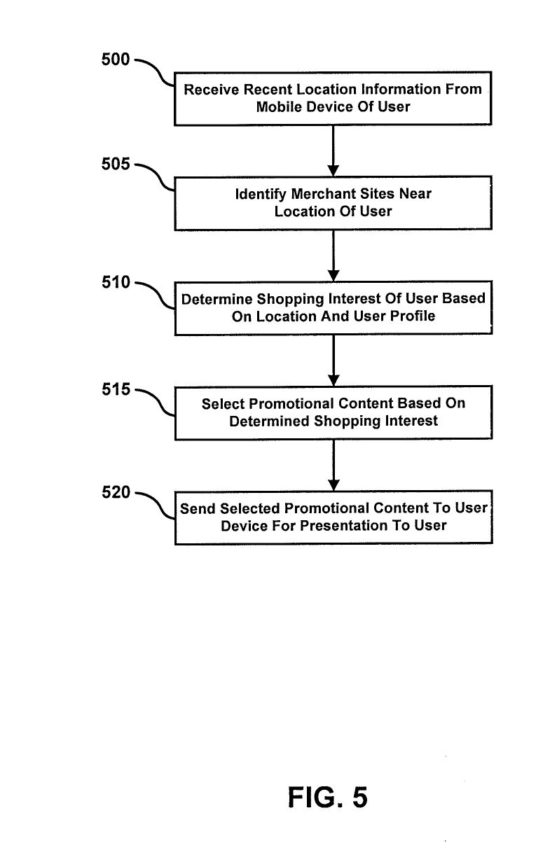

FIG. 5 illustrates an example process for selecting and providing content to a user based on the user's interests and/or location according to one or more embodiments described herein.

As described above, in one or more of the embodiments the information obtained for a particular user (e.g., information about the in-store location of the user, information about the shopping interests of the user, data about related transactions made by the user, etc.) may be used immediately or at a later time. For example, as illustrated in FIG. 4 and described above, a user's profile may be updated with information pertinent to potential interests of the user while the user is in a particular merchant site. For example, if the user uses his or her mobile device while in a store, then the information obtained for the user may be more helpful if used immediately. However, if it is determined that the user is likely to return to a store (e.g., based on the particular product area in which the user was previously browsing being a product area in which users typically return to make a purchase), then the information may be better utilized at a later time (e.g., a day or two after the user leaves the store) to remind the user about a particular product. As discussed above, the user, in various embodiments, may have to install the relevant application and/or enable a particular service before any of this information is collected and/or used.

Accordingly, the process begins in block 500 where recent location information may be received from a mobile device of the user (e.g., location data 120 may be received at content management server 112 from user device 104 of user 102, as shown in FIG. 1). Similar to block 400 of the process shown in FIG. 4 and described above, block 500 of the process shown in FIG. 5 may occur while one or more previous iterations of the process illustrated in FIG. 5 are still in progress. Thus the process may run each time a user's location changes.

Following receipt of the recent location information from the user's mobile device in block 500, the process moves to block 505 where one or more merchant sites near the location of the user's mobile device are identified. In at least one embodiment, the merchant sites identified in block 505 may be made based on the recent location information received in block 500. For example, the recent location information received in block 500 may be compared (e.g., by location map builder 165 of content management server 112 as shown in FIG. 1) against merchant site data stored in a database (e.g., maps database 195 as shown in FIG. 1). Based on such a comparison, one or more merchant sites located in some proximity to the user (e.g., the mobile device of the user) may be identified in block 505.

The process moves from block 505 to block 510 where one or more shopping interests of the user are identified based on the recent location information for the user and the user's profile. As illustrated in FIG. 4 and described above, a user's profile may be updated with information collected about products of potential interest to the user and transactions that the user has made. Accordingly, in block 510 of the process shown in FIG. 5 one or more shopping interests of the user are determined based on such stored profile information in conjunction with the recent location information obtained from the user's mobile device in block 500.

In block 515 of the process, one or more promotional content items may be selected based on the shopping interests of the user determined in block 510. Additionally, in block 520 the selected promotional content may be sent to the user's mobile device for presentation to the user. For example, in at least one embodiment the content management server 112 may be configured to intelligently select content (e.g., advertising content) in block 515 and serve the content to the user's mobile device in block 520 for presentation to the user. For example, if it is determined in block 510 that the user has a shopping interest in laptops, then in block 515 the content management server 112 may select ad content corresponding to laptops and related products, which the content management server 112 may send to the user in block 520.

### Other Example Embodiments

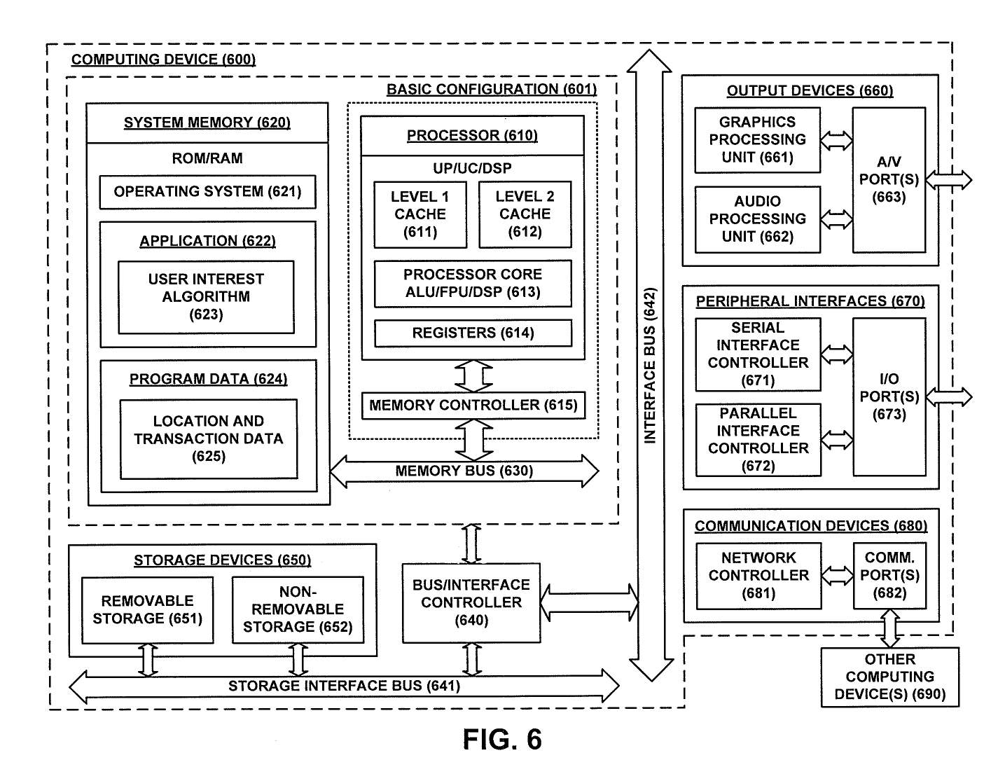

FIG. 6 is a block diagram illustrating an example computing device 600 that is arranged for selecting and providing content (e.g., promotional content such as advertisements) to a user in accordance with a shopping interest of the user, location information for the user (e.g., location information associated with the user's mobile device), or both, in accordance with one or more embodiments of the present disclosure. In a very basic configuration 601, computing device 600 typically includes one or more processors 610 and system memory 620. A memory bus 630 may be used for communicating between the processor 610 and the system memory 620.

Depending on the desired configuration, processor 610 can be of any type including but not limited to a microprocessor (μP), a microcontroller (μC), a digital signal processor (DSP), or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 can also be used with the processor 610, or in some embodiments the memory controller 615 can be an internal part of the processor 610.

Depending on the desired configuration, the system memory 620 can be of any type including but not limited to volatile memory (e.g., RAM), non-volatile memory (e.g., ROM, flash memory, etc.) or any combination thereof. System memory 620 typically includes an operating system 621, one or more applications 622, and program data 624. In at least some embodiments, application 622 includes a user interest algorithm 623 configured to determine a shopping interest of a user based on information about a location of the user (e.g., a location of a user device being utilized by the user) within a particular merchant site (e.g., a store, market, etc.), transaction information for the user indicating whether the user has conducted a related transaction, or both. The user interest algorithm 623 is further configured to determine, based on any available transaction information for the user, a type of transaction that occurred, a particular product involved in the transaction, as well as other related information about the transaction.

Program Data 624 may include location and transaction data 625 that is useful for determining a location of a user (e.g., based on information received about a location of a user device being utilized by the user) within a particular merchant site, and also whether the user conducted a transaction related to the merchant site and/or related to products available at the merchant site. In some embodiments, application 622 can be arranged to operate with program data 624 on an operating system 621 such that location and transaction data 625 for a particular user may be analyzed to determine one or more shopping interests of the user, and to select one or more promotional content items to send for presentation to the user.

Computing device 600 can have additional features and/or functionality, and additional interfaces to facilitate communications between the basic configuration 601 and any required devices and interfaces. For example, a bus/interface controller 640 can be used to facilitate communications between the basic configuration 601 and one or more data storage devices 650 via a storage interface bus 641. The data storage devices 650 can be removable storage devices 651, non-removable storage devices 652, or any combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), tape drives and the like. Example computer storage media can include volatile and nonvolatile, removable and non-removable media implemented in any method or technology for storage of information, such as computer readable instructions, data structures, program modules, and/or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media can be part of computing device 600.

Computing device 600 can also include an interface bus 642 for facilitating communication from various interface devices (e.g., output interfaces, peripheral interfaces, communication interfaces, etc.) to the basic configuration 601 via the bus/interface controller 640. Example output devices 660 include a graphics processing unit 661 and an audio processing unit 662, either or both of which can be configured to communicate to various external devices such as a display or speakers via one or more A/V ports 663. Example peripheral interfaces 670 include a serial interface controller 671 or a parallel interface controller 672, which can be configured to communicate with external devices such as input devices (e.g., keyboard, mouse, pen, voice input device, touch input device, etc.) or other peripheral devices (e.g., printer, scanner, etc.) via one or more I/O ports 673.

An example communication device 680 includes a network controller 681, which can be arranged to facilitate communications with one or more other computing devices 690 over a network communication (not shown) via one or more communication ports 682. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 600 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 can also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation. In one or more other scenarios, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those skilled within the art that each function and/or operation within such block diagrams, flowcharts, or examples can be implemented, individually and/or collectively, by a wide range of hardware, software, firmware, or virtually any combination thereof.

In one or more embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments described herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof. Those skilled in the art will further recognize that designing the circuitry and/or writing the code for the software and/or firmware would be well within the skill of one of skilled in the art in light of the present disclosure.

Additionally, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable-type medium such as a floppy disk, a hard disk drive, a Compact Disc (CD), a Digital Video Disk (DVD), a digital tape, a computer memory, etc.; and a transmission-type medium such as a digital and/or an analog communication medium (e.g., a fiber optic cable, a waveguide, a wired communications link, a wireless communication link, etc.).

Those skilled in the art will also recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method of sending promotional content in electronic form to a mobile device, comprising:
receiving, using one or more computing devices, current geographic location information indicating the current geographic location of a user from a mobile device operated by the user;
determining, using the one or more computing devices, from the current geographic location information that the user is located within a merchant site and that the user has remained within the merchant site for a first threshold period of time;
determining, using the one or more computing devices, a shopping interest of the user based at least in part on products available for sale at the merchant site;
receiving, using the one or more computing devices, transaction information indicating that the user has conducted a related transaction at the merchant site in the first threshold period of time, wherein the transaction at the merchant site comprises one or more of a purchase, a return and an exchange of a product or service;
selecting, using the one or more computing devices, promotional content in electronic form that is customized for the user by at least the shopping interest of the user and the transaction information indicating that the user has conducted the transaction, wherein the selecting promotional content in electronic form occurs within the first threshold period of time;
repeating, using the one or more computing devices, the receiving current geographic location information from the mobile device operated by the user and the determining from the current geographic location information that the user continues to remain within the merchant site;
sending, using the one or more computing devices, the promotional content in electronic form to the mobile device operated by the user, wherein the sending promotional content in electronic form to the mobile device operated by the user occurs within the first threshold period of time.

2. (canceled)

3. The computer-implemented method of claim 1, wherein the transaction information is received from one or more point-of-sale devices of the merchant site.

4. The computer-implemented method of claim 1, wherein the transaction information is received from a mobile payment system including one or more near-field-communication devices.

5. The computer-implemented method of claim 1, wherein the transaction information is received from one or more servers of a near-field-communication service provider.

6. The computer-implemented method of claim 1, wherein the transaction information is received from one or more servers of a credit card provider.

7. The computer-implemented method of claim 1, wherein the transaction at the merchant site in the first threshold period of time comprises a sale of a product.

8. The computer-implemented method of claim 1, wherein the transaction at the merchant site in the first threshold period of time comprises a return of a product.

9. The computer-implemented method of claim 10, wherein the second threshold period of time comprises multiple non-contiguous periods of time.

10. The computer-implemented method of claim 1, wherein determining the shopping interest of the user comprises determining, by the one or more computing devices, from the current geographic location information that the user is located in a particular product area of the merchant site and that the user has remained in the particular product area of the merchant site for the second threshold period of time.

11. The computer-implemented method of claim 10, wherein the promotional content in electronic form is further customized for the user by one or more products located in the particular product area of the merchant site.

12. The computer-implemented method of claim 1, wherein a first product is located in a first particular product area of the merchant site and a second product is located in a second particular product area of the merchant site, the first product being related to the second product, and further comprising:
providing, for presentation on a display of the mobile device, the promotional content in electronic form when a determination is made from the current geographic location information that the mobile device is located in one of the first particular product area of the merchant site and the second particular product area of the merchant site.

13. The computer-implemented method of claim 1, wherein the promotional content in electronic form comprises an advertisement of a first product related to a second product that is available for sale at the merchant site.

14. The computer-implemented method of claim 1, further comprising sending, using the one or more computing devices, the selected promotional content in electronic form to a computing device operated by the user.

15. A computing system for sending promotional content in electronic form to a mobile device, comprising:
at least one processor; and
a computer-readable medium coupled to the at least one processor having instructions stored thereon which, when executed by the at least one processor, causes the at least one processor to:
receive current geographic location information indicating the current geographic location of a user from a mobile device operated by the user;
determine from the current geographic location information that the user is located within a merchant site and that the user has remained within the merchant site for a first threshold period of time;
determine a shopping interest of the user based at least in part on products available for sale at the merchant site;
receive transaction information indicating that the user has conducted a transaction at the merchant site in the first threshold period of time, wherein the transaction at the merchant site comprises one or more of a purchase, a return and an exchange of a product or service;
select promotional content in electronic form that is customized for the user by at least the shopping interest of the user and the transaction information indicating that the user has conducted the transaction, wherein the instructions to select promotional content in electronic form are executed within the first threshold period of time;
repeat the instructions to receive current geographic location information from the mobile device operated by the user and to determine from the current geographic location information that the user continues to remain within the merchant site; and
send the promotional content in electronic form to the mobile device operated by the user, wherein the instructions to send the promotional content in electronic form to the mobile device operated by the user are executed within the first threshold period of time.

16. (canceled)

17. The computing system of claim 15, wherein the at least one processor is further caused to:
further determine the shopping interest of the user by determining from the current geographic location information that the user is located in a particular product area of the merchant site and that the user has remained in the particular product area of the merchant site for a second threshold period of time; and
further select the promotional content in electronic form as being based on one or more products available for sale within the particular product area of the merchant site.

18. One or more non-transitory computer-readable media storing computer-executable instructions that, when executed, cause at least one computer device to perform:
receiving current geographic location information indicating the current geographic location of a user from a mobile device operated by a user;
determining from the current geographic location information that the user is located within a merchant site and that the user has remained within the merchant site for a first threshold period of time;
determining a shopping interest of the user based at least in part on products available for sale at the merchant site;
receiving transaction information indicating that the user has conducted a transaction at the merchant site in the first threshold period of time, wherein the transaction at the merchant site comprises one or more of a purchase, a return and an exchange of a product or service;
selecting promotional content in electronic form that is customized for the user by at least the shopping interest of the user and the transaction information indicating that the user has conducted the transaction, wherein the selecting promotional content in electronic form occurs within the first threshold period of time;
repeating the receiving current geographic location information from the mobile device operated by the user and the determining from the current geographic location information that the user continues to remain within the merchant site; and
sending the promotional content in electronic form to the mobile device operated by the user, wherein the sending promotional content in electronic form to the mobile device operated by the user occurs within the first threshold period of time.

19. (canceled)

20. The one or more non-transitory computer-readable media of claim 18, wherein the computer-executable instructions cause the at least one computer device to further perform:
further determining the shopping interest of the user by determining from the current geographic location information that the user is located in a particular product area of the merchant site and that the user has remained in the particular product area of the merchant site for a second threshold period of time; and
further selecting the promotional content in electronic form as being based customized for the user based at least on one or more products available for sale within the particular product area of the merchant site.

21. The computer-implemented method of claim 1, wherein the transaction information further indicates the type of the transaction conducted, and wherein the sending the promotional content in electronic form is further based on the type of transaction conducted.

22. The computing system of claim 15, wherein the transaction information further indicates the type of the transaction conducted, and wherein the instructions to select promotional content in electronic form is further based on the type of transaction conducted.

23. The computer-implemented method of claim 18, wherein the transaction information further indicates the type of the transaction conducted, and wherein the selecting the promotional content in electronic form is further based on the type of transaction conducted.
